(19) United States
(12) Patent Application Publication
(10) Pub. No.: US 2007/0084413 A1
(43) Pub. Date: Apr. 19, 2007

(54) Easy access litter box

(76) Inventors: Christine Oertel, Roselle Park, NJ (US); John Oertel, Roselle Park, NJ (US)

Correspondence Address: JAMES RAY & ASSOCIATES, 2640 PITCAIRN ROAD, MONROEVILLE, PA, 15146, US

(21) Appl. No.: 11/582,249

(22) Filed: Oct. 17, 2006

Related U.S. Application Data
(60) Provisional application No. 60/728,075, filed on Oct. 19, 2005.

(51) Int. Cl. A01K 1/035

(52) U.S. Cl. 119/165

(57) ABSTRACT

A litter box for providing easy access for kittens and old, sick, small or disabled cats to the litter box. The litter box comprises a base tray member having each of a first predetermined shape and a first predetermined size and being formed of a first predetermined material. The base tray member has a raised lip formed on all sides adjacent an outer edge thereof and an upper litter containment tray member having each of a second predetermined shape and a second predetermined size and formed of a second predetermined material for engagement with a portion of the base tray member. The upper litter containment tray member includes a bottom portion and three side wall members formed on the base portion. The side wall members having a predetermined height. Such upper litter containment tray member has an open end for allowing such pets to enter the litter box without having to climb over any high side walls.

### CROSS REFERENCE TO RELATED APPLICATIONS

This application is closely related to and claims benefit from U.S. Provisional Application Ser. No. 60/728,075 filed Oct. 18, 2005.

### FIELD OF THE INVENTION

The present invention relates, in general, to a cat litter box, and, more particularly, the present invention relates to a two piece cat litter box which provides easy access and exit for any litter trained animal, even those pets who have physical problems.

### BACKGROUND OF THE INVENTION

Sick, old and disabled cats, and many small pets, particularly kittens, may find it difficult to enter a standard litter box. Elderly cats can develop hip or leg problems which makes it difficult for them to use a litter box. Also kittens or very small cats may find it difficult to use some litter boxes. This is particularly true where the litter box has high sides which is fairly common in litter boxes as this is an effort by the manufacturer to keep the litter in the box and not have the cat spread it over the floor as the cat scratches after using the litter box. Generally, the sides of conventional litter boxes are simply too high to accommodate all pets. Kittens may be unable or unsure how to climb, which forces these pets to have accidents outside the litter boxes and that leads to pet and pet owner frustration.

Thus, it would be advantageous if there were a litter box which could provide the security of litter boxes with high sides and yet provide easy access for pets which may otherwise have difficulty using the conventional litter box.

### SUMMARY OF THE INVENTION

In a first aspect the present invention provides a litter box for providing easy access for kittens and old, sick, small or disabled cats to the litter box. The litter box comprises a base tray member having each of a first predetermined shape and a first predetermined size and being formed of a first predetermined material. The base tray member has a raised lip formed on all sides adjacent an outer edge thereof and an upper litter containment tray member having each of a second predetermined shape and a second predetermined size and formed of a second predetermined material for engagement with a portion of the base tray member. The upper litter containment tray member includes a bottom portion. There are three side wall members formed on the base portion. The side wall members having a predetermined height and such upper litter containment tray member has an open end for allowing such pet to enter the litter box without having to climb over any high sides.

### OBJECTS OF THE INVENTION

It is, therefore, one of the primary objects of the present invention is to provide a litter box which has easy access for all cats, even those that are disabled.

Another object of the present invention is to provide a litter box which has an open end for easy access.

Still another object of the present invention is to provide a litter box which has two separate parts.

Yet another object of the present invention is to provide a litter box in which the portion that contains the litter is secured to the base by means of grippers.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the base tray of the litter box according to an embodiment of the invention.

FIG. 2 is a perspective view of the upper litter containment tray that fits on top of the base tray shown in FIG. 1.

FIG. 3 is a cross-sectional view of the base tray shown in FIG. 1 showing grips on the underside of the base tray for preventing the tray from sliding when the pet is entering, using or exiting the litter box.

FIG. 4 is a perspective view of the litter box as it is when it is completely assembled and ready for use.

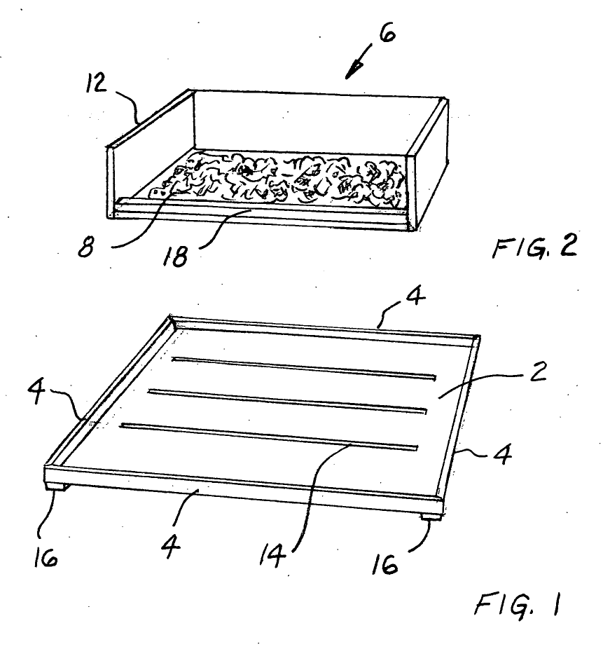

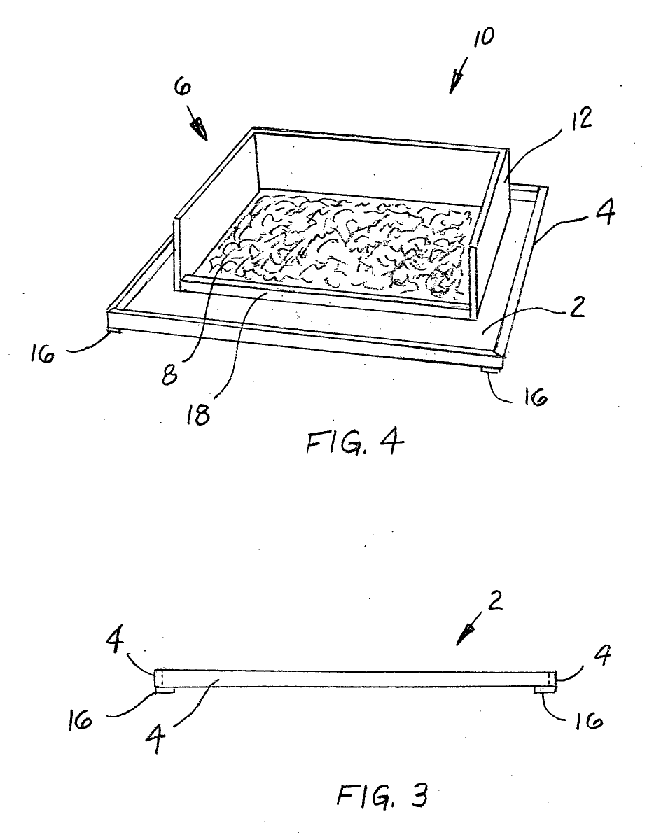

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a litter box, generally designated 10, for providing easy access for kittens and old, sick, small or disabled cats to the litter box 10. The litter box 10 comprises a base tray member 2 having each of a first predetermined shape and a first predetermined size and being formed of a first predetermined material. The base tray member 2 has a raised lip 4 formed on all sides adjacent an outer edge thereof and an upper litter containment tray member 6 having each of a second predetermined shape and a second predetermined size and formed of a second predetermined material for engagement with a portion of the base tray member. The upper litter containment tray member 6 includes a bottom portion 8. There are three side wall members formed on the base portion 12. The side wall members having a predetermined height and such upper litter containment tray member has an open end for allowing such pet to enter the litter box without having to climb over any high sides.

The base tray member 2 further includes non slip grippers 14 disposed on an upper surface thereon for engagement with the upper litter containment tray member 6 for preventing the upper litter containment tray member 6 from sliding when the pet is entering, utilizing or exiting the litter box 10. The base tray 2 member also has grips 16 disposed on the underside of the tray substantially at each corner of the tray to help in preventing the tray 2 from sliding when the pet is entering or exiting the litter box 10.

As is clearly seen in FIG. 4 the first predetermined size of the base tray member 2 is larger that said second predetermined size of upper litter containment tray member 6. This extra distance beyond the open end is designed to collect the excess litter when the cat scratches the litter after using the litter box 10. This extra distance is approximately 8 inches.

It is presently preferred that both the first predetermined shape of the base tray member 2 and the second predetermined shape of the upper litter containment member 6 are substantially rectangular.

The first predetermined size is such that the base member 2 extends sufficiently beyond the open. end of the upper litter containment tray member 6 when said upper litter containment tray member 6 is positioned on the base tray member to collect any litter scratched out by such pet.

Such upper litter containment tray member 6 further includes a small lip 18 on the open end of the upper litter containment tray member 6 to aid in containment of such pet litter.

It is also presently preferred that such first predetermined material for the base tray 2 and such second predetermined material for the upper litter containment tray 6 are both made of plastic. It is within the scope of the invention that both the base tray member 2 and the upper litter containment tray member 6 can be made of the same plastic material. It is also within the scope of the invention that they could be made of different plastics.

The predetermined height of the three side wall members 14 is sufficient to keep such litter in the upper litter containment tray 6 even when scratched by such pet using the litter box 10. This height would be equivalent to side walls on some standard litter boxes.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. A litter box for providing easy access for kittens and one of old, sick, small and disabled cats to said litter box, said litter box comprising:
(a) a base tray member having each of a first predetermined shape and a first predetermined size and being formed of a first predetermined material, said base tray member having a raised lip formed on all sides adjacent an outer edge thereof; and
(b) an upper litter containment tray member having each of a second predetermined shape and a second predetermined size and formed of a second predetermined material for engagement with a portion of said base tray member, said upper litter containment tray member including:
(i) a bottom portion;
(ii) three side wall members formed on said base portion, said side wall members having a predetermined height;
(iii) an open end on said upper litter containment tray member for allowing such pet to enter said litter box without having to climb over any high sides.

2. The litter box, according to claim 1, wherein said base tray member further includes non slip grippers disposed on an upper surface thereon for engagement with said upper litter containment tray member for preventing said upper litter containment tray member from sliding when such pet is entering, utilizing or exiting the litter box.

3. The litter box, according to claim 2, wherein said non slip grippers are made of rubber.

4. The litter box, according to claim 1, wherein said first predetermined size of said base tray member is larger that said second predetermined size of said upper litter containment tray member.

5. The litter box, according to claim 1, wherein said first predetermined shape is substantially rectangular.

6. The litter box, according to claim 5, wherein said first predetermined size is such that said base member extends sufficiently beyond said open end of said upper litter containment tray member when said upper litter containment tray member is positioned on said base tray member to collect any litter scratched out by such pet.

7. The litter box, according to claim 1, wherein said upper litter containment tray member further includes a small lip on said open end of said upper litter containment tray member to aid in containment of such pet litter.

8. The litter box, according to claim 1, wherein said first predetermined material is plastic.

9. The litter box, according to claim 1, wherein said second predetermined material is plastic.

10. The litter box, according to claim 1, wherein said second predetermined shape of said upper litter containment tray member is substantially rectangular.

11. The litter box, according to claim 1, wherein said predetermined height of said three side wall members is sufficient to keep such litter in said upper litter containment tray even when scratched by such pet using said litter box.

12. The litter box, according to claim 1, wherein said base tray member further includes non slip grips disposed on a bottom surface thereon substantially at each corner for helping to prevent the litter box from moving when such pet is entering, utilizing or exiting the litter box.

13. The litter box, according to claim 11, wherein said non slip grips are made of rubber.
